(19) United States
(12) Patent Application Publication
(10) Pub. No.: US 2015/0087428 A1
(43) Pub. Date: Mar. 26, 2015

(54) SYSTEM AND METHOD OF AUGMENTING GAMING EXPERIENCE FOR AT LEAST ONE USER

(71) Applicant: KPIT Technologies Ltd., Pune (IN)

(72) Inventors: Bhaskar Dani, Pune (IN); Omkar panse, Pune (IN); Sriram G., Pune (IN)

(73) Assignee: KPIT TECHNOLOGIES LTD., Pune (IN)

(21) Appl. No.: 14/494,617

(22) Filed: Sep. 24, 2014

(30) Foreign Application Priority Data
Sep. 25, 2013 (IN) 2484/MUM/2013

(51) Int. Cl. A63F 13/65; A63F 13/73; H04W 12/06

(52) U.S. Cl. CPC A63F 13/65; H04W 12/06; A63F 13/73
USPC 463/43

(57) ABSTRACT

The present invention provides a system and method for augmenting gaming experience for at least one user. The system comprises a vehicle data extraction module and one or more nomadic devices. The vehicle data extraction module is coupled to instrument panel cluster and a body control unit for extracting run-time information of vehicle data and parameters. The one or more nomadic devices is coupled to the vehicle data extraction module for processing the extracted information of vehicle data at run time in order to alter gaming behavior, thereby augmenting the gaming experience.

### FIELD OF THE INVENTION

The present invention relates to in-vehicle infotainment system, and more particularly relates to system and method of augmenting gaming experience for at least one user.

### BACKGROUND OF THE INVENTION

Modern day vehicles such as, but not limited to, cars, trucks, vans and Recreational Vehicles (RVs), are fitted with “infotainment systems”. An infotainment system provides entertainment to occupants of the vehicle mainly in terms of enjoying music. Often a vehicle may be fitted with a rear seat entertainment device with a larger display that provides other forms of entertainment such as a video playback. Infotainment system can also display vehicle information such as speed, temperature, seat adjustment, air conditioning etc.

Users may also bring nomadic devices such as personal consumer electronic devices. These include, but are not limited to smart phones, tablet computers, Digital Versatile Disc (DVD) players, etc. into the vehicle such as car. Occupants other than the driver may enjoy personal music or video content using these nomadic devices. For example, a rear seat occupant may use a tablet to watch a video or play a game.

Certain modern infotainment systems may also allow connecting nomadic devices to the infotainment system. This may allow the occupants to control the nomadic device using user interaction elements provided in the car. For example, driver can browse, select and play a song stored on the nomadic device using steering wheel controls. In another case, rear seat occupant may be able to watch a video stored on a smartphone onto a larger rear seat screen.

However, the integration of the existing infotainment systems with the nomadic device provide very limited use cases of music and video. Music and video are passive or one-directional forms of entertainment. Further, playing games on a tablet is limited to an experience on the tablet, which is always the same. Such forms of entertainment are very personal and provide very little interaction with the vehicle or with other occupants of the vehicle. It is not possible to enhance or influence the behavior of the game with the external parameters and environmental features, like, the driving style, speed of vehicle, or other information that be obtained from the vehicle. It is also not possible to give any emotional feedback, for example, informing the driver, that his driving is not appropriate.

Therefore, there is a need for system and method for augmenting gaming experience using run time information of the vehicle data and possibly and environmental features. Subsequently the same information may be used as a feedback to the driver in order to improve the driver's driving style and the riding comfort.

### SUMMARY

An embodiment of the present invention describes a system for augmenting gaming experience for at least one user. The system comprises a vehicle data extraction module coupled to an instrument panel cluster and a body control unit for extracting run-time information of vehicle data, and one or more nomadic devices coupled to the vehicle data extraction module for processing the extracted run time information of vehicle data in order to alter gaming behavior, thereby augmenting the gaming experience.

Another embodiment of the present invention describes a method of augmenting gaming experience for at least one user. The method comprises extracting the run time information of vehicle data, processing the extracted run-time information of vehicle data based on a predefined configuration, establishing at least one communication channel with in-built security features between one or more nomadic devices and a vehicle data extraction module, providing the processed run time information of vehicle data to one or more nomadic devices through the at least one communication channel, and integrating the received data with the gaming feature in order to alter gaming behavior, thereby augmenting the gaming experience. The method further comprises receiving inputs from one or more occupants for providing to the nomadic device. The vehicle data includes data derived on the bases of predefined parameter while vehicle is running

Further embodiment of the present invention describes a system for augmenting gaming experience for at least one user. The system comprises an infotainment unit coupled to a steering control unit, instrument panel cluster and a body control unit for extracting a run-time information of vehicle data, the infotainment unit optionally comprises a vehicle data extraction module, and one or more nomadic devices coupled to the vehicle data extraction module for processing the extracted run time information of vehicle data in order to alter gaming behavior, thereby augmenting the gaming experience. The steering control unit is coupled to at least one steering wheel switch for receiving one or more inputs of the driver to enhance the gaming experience.

### BRIEF DESCRIPTION OF THE ACCOMPANYING DRAWINGS

The aforementioned aspects and other features of the present invention will be explained in the following description, taken in conjunction with the accompanying drawings, wherein:

FIG. 1 illustrates a block diagram of a system for augmenting gaming experience for at least one user data according to an embodiment of the present invention.

FIG. 2 illustrates a block diagram of a system for augmenting gaming experience for at least one user data according to another embodiment of the present invention.

FIG. 3 illustrates a block diagram of a vehicle data extraction module according to one embodiment of the present invention.

FIG. 4 illustrates a block diagram of an infotainment unit according to one embodiment of the present invention.

FIG. 5 illustrates a block diagram of a nomadic device according to one embodiment of the present invention.

FIG. 6 illustrates the communication between a vehicle data extraction module and a nomadic device according to an embodiment of the present invention.

FIG. 7 illustrates the communication between an infotainment unit and a nomadic device according to another embodiment of the present invention.

FIG. 8 illustrates a flow diagram of a method of augmenting gaming experience for at least one user according to one embodiment of the present invention.

### DETAILED DESCRIPTION OF THE INVENTION

The embodiments of the present invention will now be described in detail with reference to the accompanying drawings. However, the present invention is not limited to the present embodiments. The size, shape, position, number and the composition of various elements of the device of the invention is exemplary only and various modifications are possible to a person skilled in the art without departing from the scope of the invention. Thus, the embodiments of the present invention are only provided to explain more clearly the present invention to the ordinarily skilled in the art of the present invention. In the accompanying drawings, like reference numerals are used to indicate like components.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention describes system and method for augmenting gaming experience for one or more users using run time information of vehicle data. The present invention describes integration of one or more nomadic devices with either a vehicle data extraction module or an infotainment unit in order to enhance gaming experience. Through this integration, it is possible to provide various extracted vehicle parameters/data to the nomadic device so as to bring the vehicle parameters/data into the game. These parameters/data can then be used to influence or alter the behavior of the game. Subsequently, the system uses the parameters derived from the extracted data to provide feedback to the driver and/or occupant. These parameters may be used to provide learning experience to the driver for improving his driving skills. It is also possible for a rear seat occupant or other occupants of the car to rate the driving ability of the driver, thereby, encouraging the driver to drive more efficiently. In one embodiment, one or more occupants traveling in the vehicle act as the one or more users who participate in the one or more games.

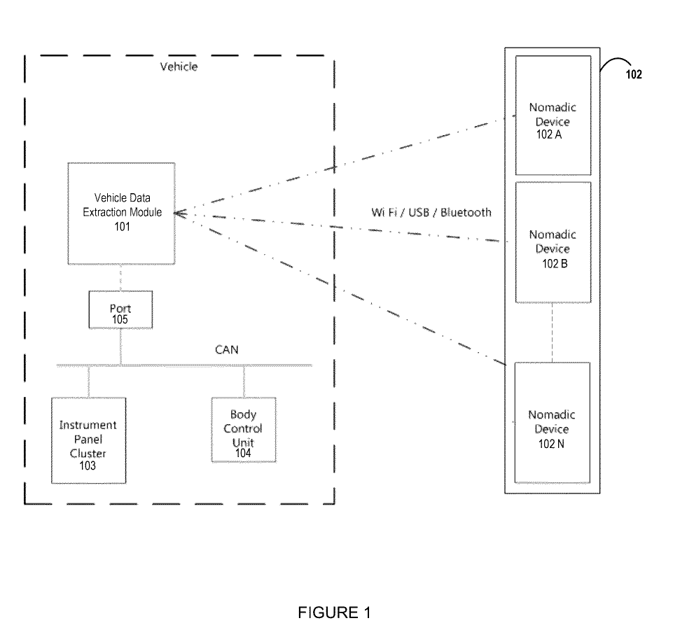

FIG. 1 illustrates a block diagram of a system for augmenting gaming experience for at least one user according to an embodiment of the present invention. The system comprises a vehicle data extraction module 101, one or more nomadic devices 102 (102A, 102B,—102N), instrument panel cluster 103 and a body control unit 104. The vehicle data extraction module is connected to the instrument panel cluster and a body control unit for extracting run-time information of vehicle data or vehicle parameters. The vehicle data and parameters include, but not limited to, brakes, steering wheel, acceleration, vehicle state, fuel usage, various indicators on the dashboard, vehicle emission data and suspension. The one or more nomadic devices are connected to the vehicle data extraction module for processing the extracted run time information of vehicle data in order to alter gaming behavior, thereby augmenting the gaming experience. For example, games include, but are not limited to, balancing games, skill games, educational games, arcade games, solo or multi-player games and action games.

The system also comprises a controller area network (CAN) which is the vehicle networking stack or CAN stack to communicate over the vehicle network. The vehicle data extraction module 102 is connected to the one or more nomadic devices 104 of the vehicle using any of the existing wired (e.g. USB) or wireless technologies such as Bluetooth, Wireless Fidelity (Wi-Fi), Universal Serial Bus (USB) communication, Wireless Local Area Network (WLAN) based communication, etc. Additionally, the vehicle data extraction module is connected to the CAN through a port. The vehicle parameters are gathered by the instrument panel cluster and the body control unit by using one or more sensors and/or hardware/software existing in the market. Based on the vehicle parameters and the sensor data, the nomadic devices augment an emotional experience of the game for the user.

With a multi-player deployment, multiple nomadic devices are connected to the vehicle data extraction module at the same time. With such a deployment, competitive gaming is made possible between two or more occupants playing the same game on their respective nomadic devices that are connected to the vehicle.

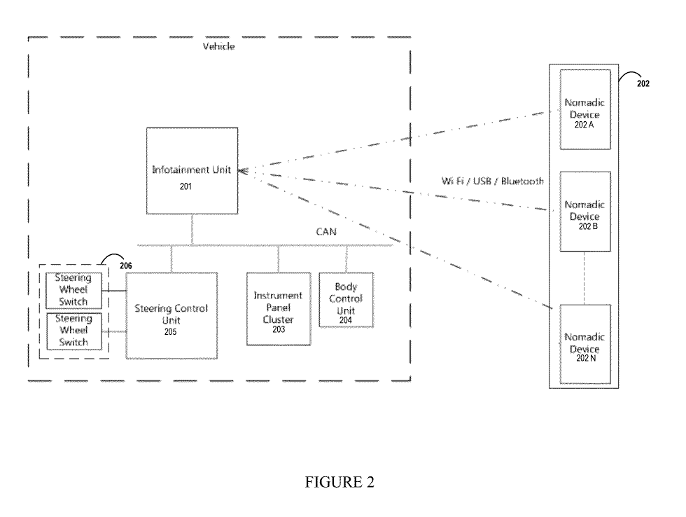

FIG. 2 illustrates a block diagram of a system for augmenting gaming experience for at least one user according to another embodiment of the present invention. The system comprises an infotainment unit 201, one or more nomadic devices 202 (202A, 102B,—102N), instrument panel cluster 203, a body control unit 204, a steering control unit 205, and one or more steering wheel switch 206. The system also comprises the vehicle extraction module 101. The vehicle extraction module 101 may be integrated with the infotainment unit 201, but preferably it is a standalone unit. The infotainment unit 201 is connected to the instrument panel cluster, the body control unit, and the steering control unit for extracting run-time information of vehicle data or vehicle parameters. The vehicle data and parameters include, but not limited to, brakes, steering wheel, acceleration, vehicle state, fuel usage, various indicators on the dashboard, vehicle emission data and suspension. The one or more nomadic devices 202 are connected to the infotainment unit 201 for processing the extracted run time information of vehicle data in order to alter gaming behavior, thereby augmenting the gaming experience. The steering control unit is coupled to at least one steering wheel switch enabling the driver to participate in the game by providing one or more inputs for enhancing the gaming experience.

During multi-player deployment, multiple nomadic devices are connected to the infotainment unit simultaneously. With such a deployment, competitive gaming is made possible between two or more occupants of the vehicle playing the same game on their respective nomadic devices that are connected to the vehicle.

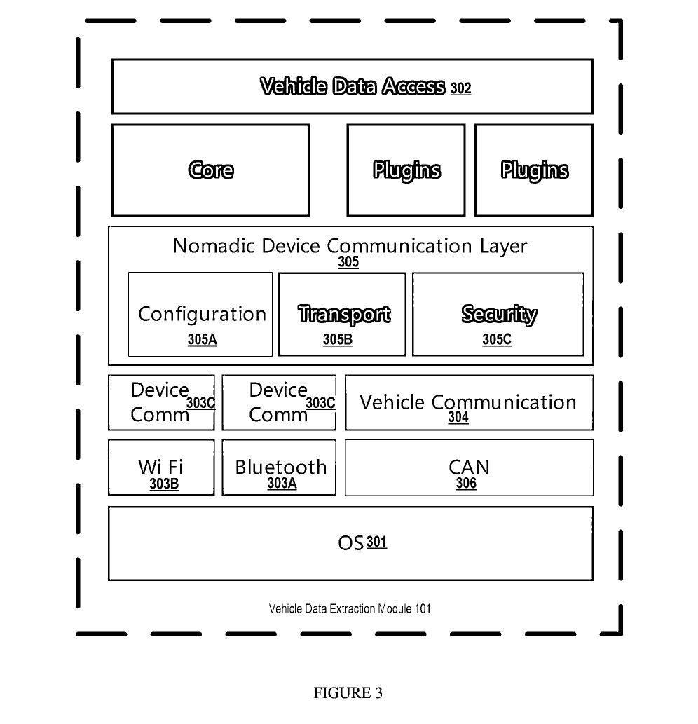

FIG. 3 illustrates a block diagram of vehicle data extraction module 101 according to an embodiment of the present invention. The vehicle data extraction module 101 comprises of an operating system (OS) 301, a communication means, a communication module, and a vehicle data accessing module 302. The operating system (OS) 301 executes one or more instructions and handles execution of one or more software installed in the vehicle data extraction module 101 for performing the necessary operations.

The communication means include wired or wireless means for coupling the vehicle data extraction module with the one or more nomadic devices. The communication means includes, but is not limited to, Bluetooth device 303A, Wi-Fi device 303B, one or more device communications 303C, and vehicle communication 304.

In one embodiment, the vehicle data extraction module 101 is connected to the one or more nomadic devices 102 using Bluetooth device 303A. The Bluetooth device 303A comprises Bluetooth stack along with required Bluetooth profiles to provide the connectivity. Mainly, the connectivity is provided using Bluetooth SPP.

In another embodiment, the vehicle data extraction module 101 is connected to the one or more nomadic devices 102 using Wi-Fi device 303B. The Wi-Fi device 303B comprises Wi-Fi driver along with required Wi-Fi communication stack to provide the connectivity.

In yet another embodiment, the vehicle data extraction module 101 is connected to the one or more nomadic devices 102 using the device communication 303C. In case of connectivity via Bluetooth 303A, the device communication component 303C provides implementation required for managing connectivity with the nomadic device 102 via Bluetooth 303A. In case of deployment with Wi-Fi 303B, the device communication component 303C provides relevant implementation for Wi-Fi 303B.

The vehicle communication component 304 provides high level implementation required to communicate with other control units of the vehicle. In certain cases it may implement the required communication protocol, e.g. diagnostic protocol, using which vehicle data or parameters can be accessed.

The communication module authenticates the one or more nomadic devices and establishes a secured communication channel between the vehicle data extraction module and the one or more nomadic devices. The communication module comprises nomadic device communication layer 305. The nomadic device communication layer provides the actual communication with the nomadic device. The nomadic device communication layer includes a configuration module 305a, a transport module 305b, and a security module 305c. The configuration module 305a provides the necessary configuration of the stack to use the underlying Device Communication technology. For example, in case of Bluetooth, it may provide configuration required to pair, connect and remember the connected device. The Transport module 305b provides the transport communication protocol to bundle various feature specific packets and transport those to the one or more nomadic devices. The security module 305c provides the core security features for authenticating the nomadic device, providing the connectivity with a trusted nomadic device and handling the transport protocol security.

The vehicle data accessing module 302 includes one or more plug-ins and a core component. The core component provides the necessary framework to add one or more required plug-ins and manage communication between respective plug-in and the nomadic device 102. The respective plug-ins actually integrates with the vehicle communication component and handles respective vehicle data or parameters. The plug-ins, after receiving the data from the vehicle communication component, uses the vehicle data access component to construct required transport packet. The packet is sent to the nomadic device communication layer via the core component.

The vehicle data extraction module 101 also comprises a controller area network (CAN) 306 which is the vehicle networking stack or CAN stack to enable communication over the vehicle network.

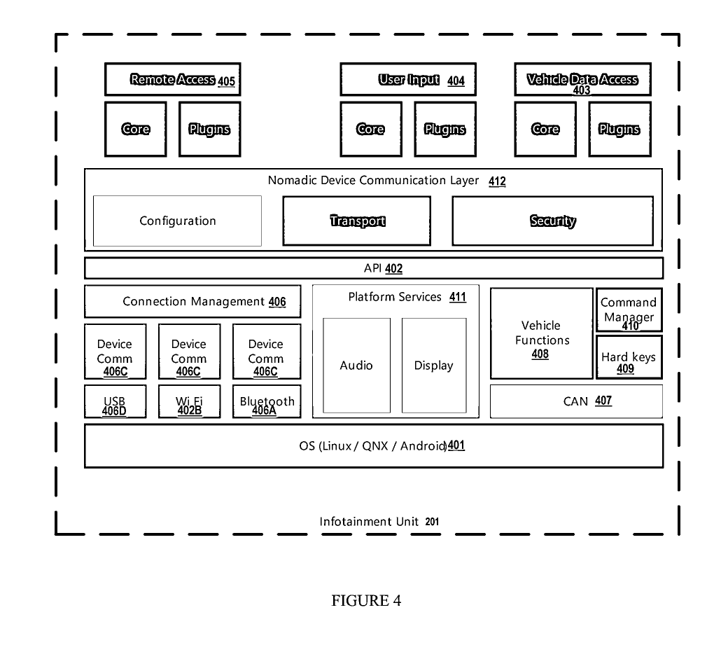

FIG. 4 illustrates a block diagram of an infotainment unit 201 according to one embodiment of the present invention. The infotainment unit 201 comprises an operating system (OS) 401, communication means, application programming interface (API) 402, a communication module, a vehicle data access module 403, a user input module 404, and a remote accessing module 405.

The operating system (OS) 401 handles execution of one or more instructions and execution of one or more software. Typically, the infotainment unit 201 is based on Linux, QNX or Android as operating system. The communication means is configured to provide connectivity between the infotainment unit and one or more nomadic device. The communication means/connection management component selects appropriate connection interfaces when multiple interfaces are available such as Bluetooth device 406A, Wi-Fi device 406B, device communication 406C, and/or universal serial bus (USB) 406D.

The Bluetooth device 406A includes a Bluetooth stack along with required Bluetooth profiles to provide the connectivity. Mainly, the connectivity is provided using Bluetooth SPP. The Wi-Fi device 406B comprises Wi-Fi driver along with required Wi-Fi communication stack to provide the connectivity. The USB 406D comprises USB driver and other components of the USB stack. The Device Communication component 406C implements required communication stack to provide the connectivity. The communication stack may be nomadic device specific to provide required connectivity. The communication stack is also specific to underlying interface viz. USB, Wi-Fi or Bluetooth.

The infotainment unit 201 also comprises a controller area network (CAN) 407 which is the vehicle networking stack or CAN stack to communicate over the vehicle network.

Vehicle functions component 408 provides high level implementation required to communicate with other control units of the vehicle. In certain cases it may implement required communication protocol, e.g. diagnostic protocol, using which vehicle data or parameters can be accessed. Apart from this, it also implements the required vehicle functions such as providing various vehicle parameters or services to change certain vehicle settings.

Hard keys component 409 provides functionality of handling hard-keys input received from a key panel or steering wheel buttons. Typically, these hard keys 409 are connected to the Infotainment unit 201 via CAN bus 407. Hence, the hard keys 409 component mainly implements functionality of interpreting relevant CAN messages to provide high level input of hard key press.

Command Manager 410 converts the hard-key press events into high level commands which are handled by Human Machine Interface (HMI) application. In case of the nomadic device integration, based on vehicle state, the command manager 410 remaps the steering wheel buttons to provide different functionality. For example, volume up and volume down buttons are remapped to provide simple up and down arrow button functionality, if the vehicle is stationary. In such a case, these button press events are handled by User Input plug-ins to send the events to the nomadic device, so that the game running on the nomadic device handles these button press events. When the vehicle starts moving again, the steering wheel keys are mapped back to their original functions and disconnected from nomadic device and stops sending events to the game.

Platform Services 411 includes various services of underlying infotainment platform software. Two main services important for nomadic device game augmentation are: Audio, and Display. The audio service allows receiving audio from the nomadic device and playing it on vehicle speakers. For example, audio of certain gaming events are played on vehicle speakers. The display service allows conditionally displaying the game onto the car front screen or rear screen. For example, when the car is stationary, game can be displayed on front display screen of the driver.

The communication module comprises a Nomadic Device Communication Layer 412. This layer provides the actual communication with the nomadic device. The nomadic device communication layer 412 includes a configuration module 412a, a transport module 412b, and a security module 412c. The configuration module 412a provides necessary configuration of the stack to use underlying device communication technology. For example, in case of Bluetooth, it may provide configuration required to pair, connect and remember connected device.

The transport module 412b provides the transport communication protocol to bundle various feature such as specific packets and transport those to the nomadic device. The security module 412c provides the core security aspects of authenticating the nomadic device, providing connectivity with a trusted nomadic device and handle transport protocol security.

The vehicle data access module 403 encapsulates the functionality of sending vehicle data to the nomadic device. The vehicle data access module 403 comprises a core component and vehicle data specific plug-ins. The core component provides the necessary framework to add required plug-ins and manage communication between respective plug-in and the nomadic device. The respective plug-ins actually integrates with the Vehicle Communication component and handles respective vehicle data or parameters. These plug-ins, after receiving data from the Vehicle Communication component, use the Vehicle Data Access component to construct required transport packet. The packet is sent to the Nomadic Device Communication Layer via the Core component.

The user input module 404 encapsulates the functionality of sending remapped user input events to the nomadic device. It has a core component and user input specific plug-ins. The Core component provides the necessary framework to add required plug-ins and manage communication between respective plug-in and nomadic device.

Respective plug-ins actually integrates with the Command Manager component 410 and handles respective hard-key press events. These plug-ins, after hard key event from the Command Manager 410, use the User Input module 404 to construct required transport packet. The packet is sent to the Nomadic Device Communication Layer 412 via the Core component.

The remote access module 405 comprises a core component and a remote access specific plug-ins. The remote access module 405 enables the user/occupant to communicate with the infotainment unit 201.

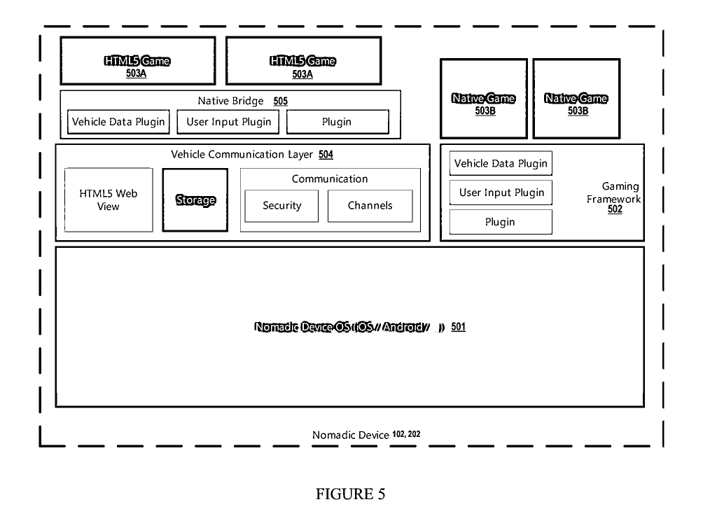

FIG. 5 illustrates a block diagram of a nomadic device 102, 202 according to one embodiment of the present invention. The nomadic device comprises an operating system (OS) 501, a communication module, a gaming framework 502, and a game supporting module 503A, 503B. The operating system 501 executes one or more instructions and runs one or more software. The communication module authenticates and establishes at least one communication channel with security features between the vehicle data extraction module and the nomadic devices. The gaming framework 502 is configured to customize and provide the run-time information of vehicle data to at least one game running on the nomadic device. The game supporting module provides support to HTML5 game 503A and native game 503B.

In one embodiment, the nomadic device 102, 202 run games developed using mainly two different technologies such as HTML5 503A and native games 503B based on a gaming framework. These two technologies provide different capabilities and access to the underlying nomadic device resources. Gaming framework provides tighter integration and much better experience since it has access to nomadic devices resources such as audio, video, gyro, accelerometer etc.

The Nomadic Device OS 501 is an Operating System of the nomadic device 102, 202. The nomadic device 102, 202 could be based on Apple iOS, Google Android or any other relevant smartphone or tablet operating system.

The communication module includes a vehicle communication layer component 504 which corresponds to the nomadic device communication layer on the vehicle data extraction module. The vehicle communication layer component 504 is responsible for establishing connection and handling communication with the vehicle data extraction module. It includes three components: Communication, Storage and HTML5 Web View.

The communication component provides the required communication channels to send or receive transport packets to or from the Nomadic Device Communication layer running on the vehicle data extraction module. It also encapsulates required security aspects of authenticating a connection, providing connectivity with a trusted Data Extractor and handle transport protocol security. The storage component provides local storage functionality to store application specific assets or data. The HTML5 Web View component provides required HTML5 web view to host and execute HTML5 based games.

Native Bridge component 505 provides internal connectivity between the HTML5 Javascript API and the underlying vehicle communication layer 504. Specific to Javascript API, it provides relevant plug-ins for example, to handle vehicle data or feature specific communication. This layer is specific to the underlying nomadic device operating system.

The HTML5 503A game is the game whose behavior is to be augmented using the vehicle data. This game is developed using HTML5 technology and runs inside HTML5 web view. It communicates with underlying Vehicle Communication Layer 504 through feature specific packets, and Javascript API specific plug-ins in the Native Bridge 505.

The gaming framework 502 enables developing much richer and engaging and highly interactive games. The gaming framework 502 provides tighter integration with the underlying nomadic device capabilities and allows access to graphics and audio resources along with inputs such as touch screen, GPS, gyro and accelerometer. There are various gaming frameworks available; however, an embodiment of the present invention is based on Unity, which is an industry-leading framework for developing games on Apple iOS and Android platforms.

In this embodiment, Unity framework plug-ins are envisaged. These plug-ins provide integration of the gaming framework 502 with the Vehicle Communication Layer 504. There are various plug-ins such as vehicle data plug-in, and user input plug-in.

The vehicle data plug-in acts as a data provider and provides the vehicle data or parameters received from the vehicle to the game developer in a similar manner as that of other data providers already built into the gaming framework. Therefore, for a game developer, it is yet another data source and the game developer does not have to do anything additional in order to receive the vehicle data.

The user input plug-in, similar to built-in touch screen or gyro plug-in, provides user input events received from the vehicle to the game developer to act upon.

The Native game 503B is developed using a gaming framework, which is to be augmented using the vehicle data. It communicates with underlying Vehicle Communication Layer 504 through respective plug-ins developed for the gaming framework 502.

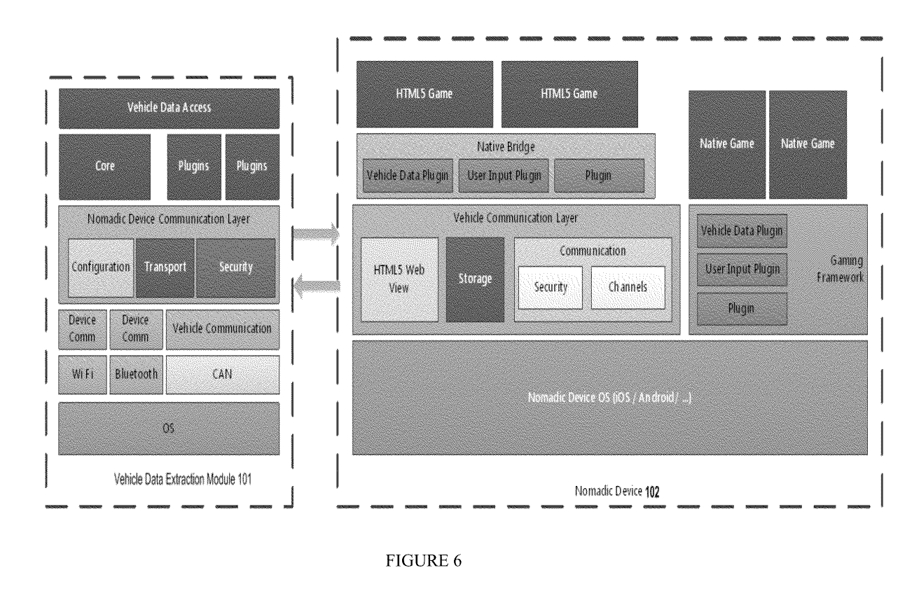

FIG. 6 illustrates the communication between a vehicle data extraction module 101 and a nomadic device 102 according to an embodiment of the present invention. Vehicle Communication Layer on the nomadic device communicates with the Nomadic Device Communication Layer on the vehicle data extraction module. Between these two components, secure transport of the vehicle data is handled. The actual transport happens through underlying technologies such as Bluetooth or Wi-Fi.

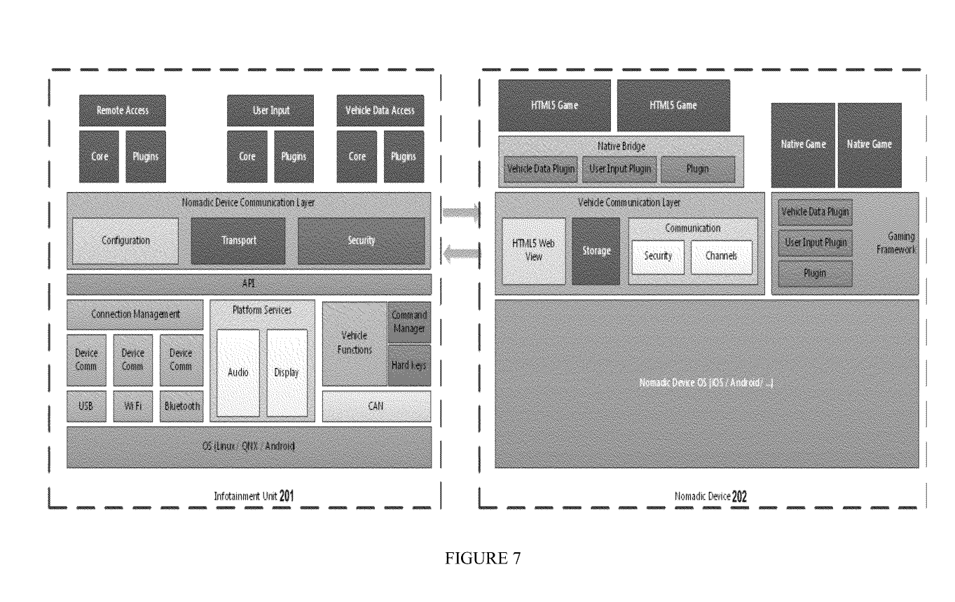

FIG. 7 illustrates the communication between the Infotainment unit 201 and the nomadic device 202 according to another embodiment of the present invention. The vehicle communication layer on the nomadic device communicates with the nomadic device communication layer on the infotainment unit. Between these two components, secure transport of the vehicle data is handled. The actual transport happens through underlying technologies such as USB, Bluetooth or Wi-Fi.

As previously explained, augmenting the gaming experience mainly involves altering the game behavior based on vehicle data. For example, in a balancing type of a game, balance may be lost based on vehicle speed and steering angle. If the speed is above a certain threshold and the steering angle is sharp, it can induce “disturbance” in the game, making it more difficult to balance whatever needs to be balance in the game. Similar disturbance can be induced based on vehicle acceleration or sudden braking Various available vehicle parameters or combinations can be used creatively to induce the disturbance to make it further more difficult to maintain balance in the game.

In an action game, the target in the game can move unexpectedly based on the combination of various vehicle parameters and respective parameter values. In one scenario, the direction and speed of the object used to hit the target (e.g. bullet, arrow, stone, etc.) can get affected based on vehicle parameters or combinations.

In another scenario, based on vehicle speed and vehicle emission related parameters, the environment in the game such as wind, visibility, fogginess, smoke etc. can be altered. In case of educational games, vehicle parameters such as speed and steering angle may be used to calculate angle of banking of road and check in reality and at run time whether turning feels safe or not.

Emotional feedback and Interaction

As a result of augmenting the game behavior using vehicle data, the game may become very difficult to play. As the player starts to lose, he or she may provide direct verbal feedback to the driver to drive carefully. In one scenario, the user/occupant rates the driving skills of the driver within the game. This game may be integrated with a social networking platform and rating of the driver can get posted onto the social networking platform, forcing the driver to improve his/her driving skills. This will provide more interaction among driver and other occupants and ensure that the driver is careful about the way he/she drives

The Infotainment unit deployment provides additional special interaction possibility—for example, when the vehicle is stopped at a signal, the steering wheel keys may be remapped to provide a different function. When remapped, the steering wheel button press events can be sent to the game running on the nomadic device. This allows special interaction between the driver and the player using the nomadic device. Pressing of a steering wheel button can be used, for example, to poke in the game. Game developer can use it as most appropriate—for example to move a target in an action game or disturb the balance by introducing a shake in a balancing game.

Apart from such direct interaction, when the vehicle is stationary, game may be displayed on the front display screen—thus, allowing the driver to see how the player is doing or what is the rating that is provided for his driving skills.

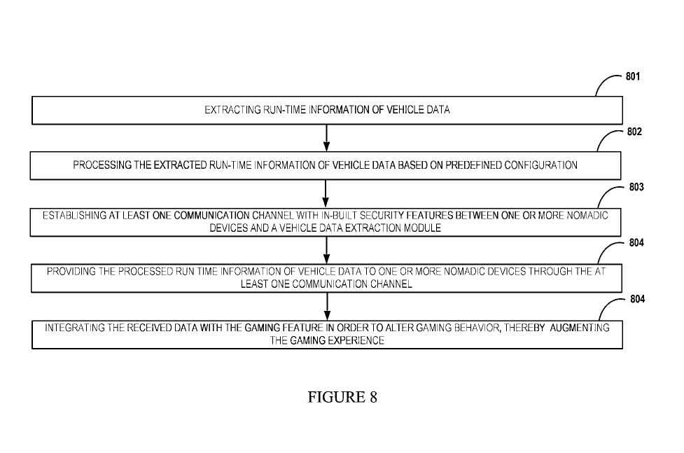

FIG. 8 illustrates a flow diagram of a method of augmenting gaming experience for at least one user according to one embodiment of the present invention. At step 801, run-time information of vehicle data is extracted. At step 802, the extracted run-time information of vehicle data is processed based on a predefined configuration. At step 803, at least one communication channel with in-built security features is established between one or more nomadic devices and a vehicle data extraction module. At step 804, the processed run time information of the vehicle data is provided to one or more nomadic devices through the at least one communication channel. At step 805, the received data is integrated with the gaming feature in order to alter gaming behavior, thereby, augmenting the gaming experience.

Although the invention of the system and method has been described in connection with the embodiments of the present invention illustrated in the accompanying drawings, it is not limited thereto. For example, all types of games running on various gaming frameworks can be played and the gaming behavior can be augmented for all games without any limitation. Other than the exemplary ones mentioned in the above description, any and all the vehicle data and parameters of the vehicle can be used to augment the gaming behavior. Security for the communication taking place between the vehicle data extractor module and the nomadic device, or between the infotainment device and the nomadic device may be achieved using different features and mechanisms known in the art. The method of the present invention is platform independent and as such is can be deployed on various operating systems as required by the nomadic devices.

When the vehicle is stationary, the steering wheel buttons can be remapped to perform various functions so that the driver can directly or indirectly participate in the game and receive feedback in various forms. Additionally, vehicle data other than the steering wheel, like, braking, acceleration, etc. may be used to augment the gaming behavior. The vehicle data accessing module may comprise of different types of data and user plug-ins according to the type of the gaming framework. It will be apparent to those skilled in the art that various substitutions, modifications and changes, as suggested, may be made thereto without departing from the scope and spirit of the invention.

We claim:

1. A system for augmenting gaming experience for at least one user, the system comprising:
a vehicle data extraction module coupled to an instrument panel cluster and a body control unit for extracting a run-time information of vehicle data and parameters; and
one or more nomadic devices coupled to the vehicle data extraction module for processing the extracted run time information of vehicle data in order to alter gaming behavior, thereby augmenting the gaming experience.

2. The system as claimed in claim 1, wherein the vehicle data extraction module comprises:
an operating system for executing one or more instructions;
communication means for coupling the vehicle data extraction module with the one or more nomadic devices;
a communication module for authenticating the one or more nomadic devices and establishing a secured communication channel between the vehicle data extraction module and the one or more nomadic devices; and
a vehicle data accessing module comprising of at least one plug-in and a core component, the core component providing necessary framework to add one or more required plug-ins.

3. The system as claimed in claim 1, wherein the vehicle data extraction module is configured to capture one or more vehicle data and parameters from the instrument panel cluster and the body control unit, to alter the gaming behavior.

4. The system as claimed in claim 1 further comprising an infotainment unit for providing gaming features to the one or more nomadic devices, the infotainment unit optionally comprises the vehicle data extraction module.

5. The system as claimed in claim 4, wherein the infotainment unit comprises:
an operating system for executing one or more instructions;
communication means for coupling the vehicle data extraction module with the one or more nomadic devices;
a communication module for authenticating the one or more nomadic devices and establishing at least one communication channel along with security features between the vehicle data extraction module and the one or more nomadic devices;
a remote accessing module configured for exchanging data between the infotainment unit and the one or more nomadic device;
an user input module configured to receive hard keys input and providing remapped user input events to the nomadic device; and
a vehicle data accessing module includes at least one plug-in and core component, the core component provides necessary framework to add one or more required plug-ins.

6. The system as claimed in claim 4, wherein the infotainment unit is configured to capture steering control data based on vehicle state, to alter the gaming behavior, the vehicle state includes stationary state and moving state.

7. The system as claimed in claim 5, wherein the infotainment unit is configured to capture steering control data based on vehicle state, to alter the gaming behavior, the vehicle state includes stationary state and moving state.

8. The system as claimed in claim 1, wherein the one or more nomadic devices comprise:
an operating system for executing one or more instructions;
a communication module for authenticating and establishing at least one communication channel with security features between the vehicle data extraction module and the nomadic devices;
a gaming framework configured to customize and provide the run-time information of vehicle data to at least one game running on the nomadic device; and
a game supporting module for providing support to HTML5 game and native game.

9. The system as claimed in claim 1 further comprising a controller area network for coupling the vehicle data extraction module with the instrument panel cluster and the body control unit.

10. A method of augmenting gaming experience for at least one user, the method comprising:
extracting run-time information of vehicle data;
processing the extracted run-time information of vehicle data based on predefined configuration;
establishing at least one communication channel with in-built security features between one or more nomadic devices and a vehicle data extraction module;
providing the processed run time information of vehicle data to one or more nomadic devices through the at least one communication channel; and
integrating the received data with the gaming feature in order to alter gaming behavior, thereby augmenting the gaming experience.

11. The method as claimed in claim 10, wherein the vehicle data includes data derived on the bases of predefined parameter while vehicle is running

12. The method as claimed in claim 10, further comprising receiving inputs from one or more occupants for providing to the nomadic device.

13. A system for augmenting gaming experience for at least one user, the system comprising:
an infotainment unit coupled to a steering control unit, instrument panel cluster and a body control unit for extracting a run-time information of vehicle data, the infotainment unit optionally comprises a vehicle data extraction module; and
one or more nomadic devices coupled to the vehicle data extraction module for processing the extracted run time information of vehicle data in order to alter gaming behavior, thereby augmenting the gaming experience.

14. The system as claimed in claim 13, wherein the steering control unit is coupled to at least one steering wheel switch for receiving one or more inputs of the driver to enhance the gaming experience.
